(19) United States
(12) Patent Application Publication
(10) Pub. No.: US 2004/0122767 A1
(43) Pub. Date: Jun. 24, 2004

(54) Method for secure, anonymous electronic financial transactions

(76) Inventor: Bernardo Nicolas Sanchez, Toronto (CA)

Correspondence Address: MARKS & CLERK, 1075 NORTH SERVICE ROAD WEST, SUITE 203, OAKVILLE, ON, L6M 2G2, CA

(21) Appl. No.: 10/476,496

(22) PCT Filed: Apr. 24, 2002
(86) PCT No.: PCT/CA02/00635

(30) Foreign Application Priority Data
May 11, 2001 (CA) 2347396

(51) Int. Cl. G06F 17/60

(52) U.S. Cl. 705/40; 705/26

(57) ABSTRACT

AN electronic business payment system is provided which provides secure anonymous payment of charges between a seller and a purchaser. The details of the sales transaction are related to a transaction key and the payment is processed only be being related to the transaction key. In this fashion, the seller receives confirmation of payment, but does not need to know any details concerning the purchaser. The purchaser is thus able to make anonymous purchases without needing to provide details concerning, for example, details of the credit card used for payment. An electronic business payment system with improved security features over the prior art is thereby provided.

### FIELD OF THE INVENTION

The present invention generally relates to a method for effecting payment of charges in an electronic business application, and in particular, to a method for conducting secure, anonymous financial transactions.

### BACKGROUND OF THE INVENTION

With the increasing use of distance technologies, from the credit card swipe unit at the local grocery store to the globally available Internet, the opportunities to engage in electronic transactions has rapidly increased over the past several years. With this increase in electronic transactions, the opportunities for unwanted exposure of confidential information has also increased. In particular, a significant area of concern is the inadvertent and/or unwanted distribution of credit card information.

To engage in a credit card transaction, or debit card, or the like, the cardholder must provide the card data to authenticate the transaction. Often the card data must be given directly to the vendor, and in the case of online vendors, this information is often stored by the vendor for future reference. Even if the potential for errors or abuse of the information by the vendor, or its employees, are ignored, the credit card data is exposed both in the transfer between parties and in the subsequent authentication.

Wherever credit cards or the like are used, the possibility for abuse of the system is possible since the vendor obtains access to the credit card information of the purchaser. This abuse can occur at, for example, the local restaurant, but might also occur in an electronic transaction conducted on, for example, a network system such as, for example, the Internet.

While encryption methods are commonly used to make theft of this information more difficult, not all systems use such encryption methods, and even with encryption methods in place, the information might still be obtained by sophisticated abusers of the system as the information is passed from node to node and therefore might be intercepted at multiple points on the system.

Accordingly, purchasers are becoming increasing wary of releasing credit card information.

### SUMMARY OF THE INVENTION

Accordingly, it is a principal object of the present invention to provide a secure system for payment of the sale price of a sale from a purchaser to a seller, without providing the credit card information of the purchaser to the seller.

The foregoing objects are attained by a system wherein a unique transaction key is generated between the purchaser and the seller and the transfer of funds is linked to the transaction key, without the need for the credit card information to be passed to the seller.

Accordingly, the present invention provides a method of completing a purchase between a purchaser and a seller utilizing an electronic payment system; comprising the steps of:

(a) having said seller notify a first financial institution of a sale for a predetermined sale price, which first financial institution has on file information related to said seller;

(b) having said first financial institution establish a transaction key related to said sale;

(c) notifying said purchaser of said transaction key, said sale price, and the identity of said first financial institution;

(d) having said purchaser contact a second financial institution, which second financial institution has on file, information related to the payment preferences of said purchaser

(e) notifying said second financial institution of said transaction key, and the identity of said first financial institution;

(f) establishing a connection between said first financial institution and said second financial institution, having said first financial institution notify said second financial institution of said sale price, and having said second financial institution notify said purchaser of said sale price related to said transaction key;

(g) having said purchaser authorize the payment of said sale price related to said transaction key;

(h) having said second financial institution, after receiving authorization for payment, effect payment of said sale price, related to said transaction key, to said first financial institution; and

(i) having said second financial institution confirm payment of said sale price to said purchaser, and having said first financial institution confirm payment of said sale price to said seller.

A first advantage of the system of the present invention, is that the credit card number of the purchaser is known only by the second financial institution, and is not passed to the vendor or to the first financial institution. The transfer of funds between the second and the first financial institutions is related only to the transaction key. No other information is necessary. The purchaser can pre-establish a relationship with the second financial institution (by telephone, hard card, personal attendance, or other secure transaction method), and provide the second financial institution with all necessary information related to the purchaser's credit cards, or the like, and their payment preferences (e.g. which credit card to use first). Once this information is provided to the second financial institution, there is no need for this information to be re-entered into the system.

A second advantage of the system of the present invention is that the business transaction may be conducted anonymously in that the first financial institution (and the seller) do not know any information regarding the purchaser. The first financial institution merely receives payment from the second financial institution related to the transaction key. Thus, it can confirm payment has been received from the second financial institution but does not know the identity of the purchaser.

Other features of the present invention, as well as other objects and advantages attendant thereto, are set forth in the following description and the accompanying drawings in which like reference numerals depict like elements.

### BRIEF DESCRIPTION OF THE DRAWINGS

An embodiment of the system of the present invention will now be described, by way of example only, by reference to the following drawings wherein:

FIG. 1 is a schematic drawing illustrating the steps of a transaction conducted in accordance with the present invention; and

FIG. 2 is a flowchart showing the steps of a method for implementing the invention.

### DETAILED DESCRIPTION

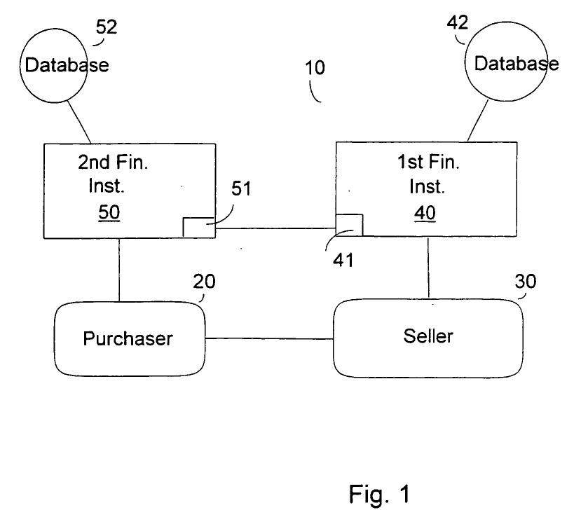

FIG. 1 is a schematic representation (10) of the system of the present invention. To start the process, a purchaser (20) and a seller (30) agree to an electronic business transaction wherein the purchaser agrees to purchase goods and/or services from the seller. The purchaser (20) is typically an individual acting on their own behalf, but may also include an individual acting on behalf of a business, or may include an automated purchasing system such as for example, an automated computer system which might, for example, order office supplies, or the like once a pre-set minimum level has been reached.

The seller (30) may also be an individual acting on their own behalf, but more likely, is an individual acting on behalf of a business. This can include any type of business where payment by credit card might be used. Additionally, the seller may also be an automated system such as, for example, a parking meter, a vending machine, a ticket machine, a gas station pump, an ATM (automated teller machine) or the like, wherein the purchaser would pay for goods or services, or conduct financial transactions using a credit card through an automated machine.

It should be noted that the term “credit card” is used throughout the present document, but this term is used in a broad sense to include any of a number of different non-cash payment methods such as, for example, traditional credit cards, debit cards, so-called “smart” cards, prepaid cards, or the like.

The transaction between the purchaser and the seller may be conducted in person, such as, for example, in a store or a restaurant, but may also be conducted over the telephone using an attendant or by using IVR technology, using a computer with a direct link between the purchaser and the seller, using a computer over a networked system, such as for example the system currently referred to as the Internet. A transaction might also be conducted by having the purchaser simply be in the vicinity of a vending machine, or other automated machine.

In order to complete the sale transaction, the seller (30) notifies its financial institution (40) of the proposed sale including the sale price. The seller's financial institution (or the first financial institution) acts on behalf of the seller, and has information related to the seller. This information might include for example, the seller's name, addresses, details of the seller's business accounts and the like, and this information is preferably stored in a database (42) accessible only by the first financial institution (40).

No other information, other than the seller's identity and the sale price, needs to be supplied to the first financial institution.

On receipt of the notification of a proposed sale, the first financial institution generates a transaction key related to the sale. The transaction key will preferably be an alphanumeric code which is preferably a unique number for that transaction. This number may be randomly generated, or may be a fixed number (such as, for example, the case of a vending machine which might always use a single transaction key). The transaction key might also be a fixed, sequential key (e.g. a fixed first portion to identify the seller, and a series of sequential numbers to identify, for example, different staff members). Preferably, the transaction key contains a code to uniquely identify the first financial institution, so that this information does not need to be inputted.

A time limit might also be established for improved security so that the transaction must be completed within a certain time frame, or else the transaction key is no longer valid.

The seller informs the purchaser of the sale price, the transaction key, and if not included in the transaction key, the identity of the first financial institution. This notification might be given orally, or by simply posting the fixed transaction key, and/or other information on the vending machine, or other automated machine, for example, but might also be supplied to the purchaser in some other fashion, as discussed hereinbelow.

The purchaser then contacts the second financial institution (50) and provides them with the transaction key, and if required-, the identity of the first financial institution (40). Once the transaction key and identity of the first financial institution are known, the second financial institution contacts the first financial institution to determine the sale price. Alternatively, the purchaser might enter the sale price into the system. However, it is preferred that the second financial institution contact the first financial institution to obtain the sale price.

Contact between the purchaser and the second financial institution might be established using a device such as, for example, a standard telephone. More preferably, however, the contact is established using an Internet-enabled device, and in particular, an Internet-enabled cellular telephone, a computer, a personal digital assistant (PDA), or generally any device which can gain access to an Internet connection, or to an IVR (interactive voice response) application, or the like.

Access to the second financial institution might be controlled by, for example, user-ids, passwords, PIN (personal identification number) numbers or the like, or may simply be controlled and restricted to only those who have a specific particular device, such as a specific cellular telephone. Preferably, the specific cellular telephone would also include security features such as user-ids, passwords, PIN numbers or the like.

Other security features might include the use of current PKI (Public Key Infrastructure) technology, but might also include other current or future verification and identification technologies, such as, for example, digital thumb printing or retinal scans, or the like.

The transaction key, when obtained from the seller, might be inputted to the purchaser's access device manually. Preferably, however, the seller is able to transmit the transaction key directly to the device of the purchaser, by for example, IR (Infrared) transmission and/or a proximity device which the purchaser's device could read, or the like.

The second financial institution has access to the payment preferences of the purchaser. Preferably, these preferences are maintained in a purchaser database (52) which contains information related to the preferences of the purchaser. For example, this can include details such as name, address and the like, and in particular, instructions on the payment of transactions. These payments might be charged to the purchaser's credit card, or might be withdrawn directly from an account of the purchaser. The payment preferences might be set to automatically follow the pre-set instructions of the purchaser, or the purchaser might be able to select from a variety of payment options for each transaction.

The second financial institution then contacts the first financial institution, through either a direct computer connection, or more preferably, through a secure Internet-based system, to obtain any relevant data related to the transaction key. This might include the sale price of record with the first financial institution, and any payment options, as discussed hereinbelow.

Contact between the first financial institution (40) and the second financial institution (50) is preferably conducted using software (and, if necessary, hardware), designed to facilitate correspondence between financial institutions. In this embodiment, a portion of the first financial institution (41) handles correspondence between the first financial institution (40), and a corresponding portion (51) of second financial institution (50). Contact between the financial institutions might also be handled or facilitated by utilizing the services of outside third parties.

Once provided with this information, the second financial institution contacts the purchaser to receive authorization to attend to payment to the first financial institution. The purchaser then provides authorization to the second financial institution to proceed with payment.

At this time, the second financial institution arranges to obtain the finds either from the purchaser's account or by charging the credit card of the purchaser. These funds are then transferred to the first financial institution, preferably according to a pre-established method, together with the transaction key. After receiving the funds, the first financial institution preferably confirms receipt to the second financial institution. The second financial institution then confirms to the purchaser that the funds have been transferred and that the transaction has been settled.

The first financial institution receives the funds and, using the transaction key, arranges to deposit the finds into the account of the seller. The first financial institution then confirms to the seller that the funds have been received.

Using this method, in accordance with the practice of the present invention, the purchaser has confirmation that the funds have been paid to the seller. The seller also has confirmation that the funds have been received from the purchaser. However, the seller has no record of the credit card information of the purchaser. In fact, using this system, the seller needs little, or preferably no, personal information about the purchaser. Accordingly, the purchaser is free to make anonymous purchases using this technique.

Preferably, release of any personal information is controlled by the purchaser.

The purchaser is also assured that only the specific transaction can take place since the transaction key is preferably viable only for that specific transaction, and/or the authorization of the purchaser is required before any transaction can proceed. The seller, and the first financial institution are not provided with any financial information related to the purchaser.

Further, password protection might be established on the transaction key so that only the password holder could make a payment, or receive payment, related to a transaction key. Using this feature, the purchaser and seller would exchange the password, and would provide the password to their respective financial institution.

The sale price can be inputted into the device of the purchaser, or can also be transmitted to the purchaser's device from the seller. Most preferably, however, the second financial institution obtains the sale price from the first financial institution, or at least, verifies the sale price with the first financial institution prior to processing the remainder of the transaction. If necessary, the second financial institution can convert the payment currency in effect at that time so that the purchaser can determine the cost of the purchase in a desired currency.

Also, as previously stated, based on the sale price, the first financial institution can preferably establish various payment options. These could include, for example: (i) a fixed amount wherein only the specific amount of the sale can be accepted; (ii) a fixed amount plus tip, wherein the purchaser must pay at least the sale price, but might also add additional funds as, for example, a tip (such as in a restaurant situation); and (iii) a multiple payment option wherein two or more purchasers can pay against the related transaction key, provided that at least the sale price is paid, in total. Combinations of these options might are also possible.

The purchaser can also establish a transaction key which is kept open and can be used for scheduled, routine payments. This could include, for example, payments made on a regular basis such as payments for rent, electricity, telephone charges, and the like. Access to these transaction keys would preferably be controlled by password protection.

Similarly, an open transaction key might be established for payment of funds to a deposit account arrangement, such as, for example, an account used for on-line stock trading. Again, access to these transaction keys would preferably be controlled by password protection.

The purchaser can also place restrictions on the use of their account with the second financial institution. These might include restrictions allowing only limited use of the account from devices other than the specific access device, described hereinabove. This would allow some use of the account by the purchaser in situations where the specific access device was inoperative or unavailable. Accordingly, for example, should a cellular phone become lost, stolen or damaged, the purchaser still has limited access to their account.

Additional restrictions might be placed on the use of an account. For example, the second financial institution might be given instructions to disallow purchases based on age. Thus, those persons under a certain age may not be able to purchase items such as liquor, cigarettes and the like, in contravention of government regulations. Additional restrictions might be placed on the account so that purchases of greater than a pre-established sale price cannot be made. Also, restrictions could be placed on the account so that the account could not be accessed during specific time periods, such as during selected periods of the day, week, month etc.

The financial institutions can be any of a number of organizations which can act on behalf of the purchasers or the seller. These can include, but are not limited to banks, credit card companies, telephone companies, specific processing centres established for the purposes of implementing the system of the present invention or the like. While it is preferred that the first and second financial institutions are different entities, it will be understood that a single financial institution may act as both the first and second financial institution.

Accordingly, in accordance with the goals of the present invention, the disclosed system thus provides a bridging system which facilitates payments between purchasers and sellers while maintaining the ability to have a secure, anonymous electronic business transaction.

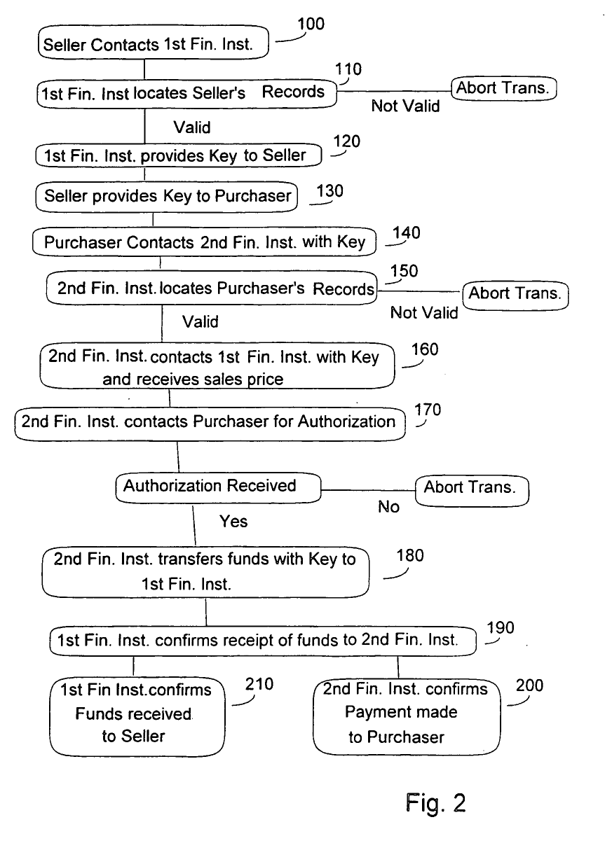

With respect to FIG. 2, a flow chart of the decision process and steps used in the practise of one embodiment of the present invention are shown, wherein it is assumed that a seller and a purchaser have agreed to terms regarding a sale of goods or services.

In step 100, the seller contacts a first financial institution and provides details of the sales transaction, including the sale price. In step 110, the first financial institution locates its records concerning the seller. If the seller does not provide valid information, or if so other problem arises, the transaction is aborted. Assuming however, that the seller's records etc. are valid, in step 120, the first financial institution provides the seller with a transaction key. In step 130, the seller provides the transaction key to the purchaser.

In step 140, the purchaser contacts the second financial institution and provides the transaction key. The second financial institution locates information regarding the purchaser in step 150, and if the information retrieved is valid, the transaction is processed. Otherwise, the transaction is aborted.

Assuming the retrieved information is valid, the second financial institution contacts the first financial institution and provides the transaction key in step 160, and receives information regarding the sale price. The second financial institution then contacts the purchaser in step 170, and requests authorization to attend to payment of the sale price to the first financial institution. If authorization is not received, or is not received in a valid time period, the transaction is aborted. If authorization is received, the second financial institution transfers funds to the first financial institution, in a prearranged fashion, together with the transaction key in step 180. The first financial institution confirms receipt of the funds to the second financial institution in step 190. The second financial institution, in step 200 confirms to the purchaser that funds have been transferred from their account to the first financial institution, and the first financial institution, in step 210 confirms to the seller that funds have been received.

It should also be noted that the system can also be used if an item is returned for credit. For example, should this occur, the seller can partially credit or reverse the full amount of the charge to the purchaser or purchasers (either individually or in a combined fashion). Again, this can occur without the seller knowing the identity or financial information of the purchaser.

It should be emphasised that no information concerning the credit card, or other payment device, has been transferred to the seller. Should the need arise, the first financial institution and the second financial institution could work together to associate the seller and the purchaser (or purchasers), but this would be considered to be an unusual situation which would not normally need to be used.

The system of the present invention is preferably conducted using only an electronic payment system, such that little or no paper receipts are required. Electronic receipts are preferably issued which can be checked or reviewed using the access devices (such as, for example, a computer, a cellular telephone, a PDA, or the like) described hereinabove. The system could also be established to provide receipts for selected search criteria, such as, for example, a seller may wish to review unpaid transactions, or a purchaser may wish to review purchases made in the current day, in the last month, or the like.

The system may also be set up to provide “alerts” if selected conditions exist, in order to inform the purchaser of account or financial activity. For example, an alert could be provided each time a payment has been made, or is received. Alerts could also be generated if a purchase is made which is above a pre-set limit, or if a successful or unsuccessful log-in attempt has been made. These features allow the purchaser to be notified if there are possible security issues to be addressed.

The “alerts” could be provided by sending an e-mail message to the purchaser, but might also be through a pager, a telephone message, a message sent to the user's access device, or the like.

Thus, it is apparent that there has been provided, in accordance with the present invention, an electronic business payment system which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

We claim:

1. A method of completing a purchase between a purchaser and a seller utilizing an electronic payment system; comprising the steps of:
(a) having said seller notify a first financial institution of a sale for a predetermined sale price, which first financial institution has on file information related to said seller;
(b) having said first financial institution establish a transaction key related to said sale;
(c) notifying said purchaser of said transaction key, said sale price, and the identity of said first financial institution;
(d) having said purchaser contact a second financial institution, which second financial institution has on file, information related to the payment preferences of said purchaser
(e) notifying said second financial institution of said transaction key, and the identity of said first financial institution;
(f) establishing a connection between said first financial institution and said second financial institution, having said first financial institution notify said second financial institution of said sale price, and having said second financial institution notify said purchaser of said sale price related to said transaction key;
(g) having said purchaser authorize the payment of said sale price related to said transaction key;
(h) having said second financial institution, after receiving authorization for payment, effect payment of said sale price, related to said transaction key, to said first financial institution; and
(i) having said second financial institution confirm payment of said sale price to said purchaser, and having said first financial institution confirm payment of said sale price to said seller.

2. A method as claimed in claim 1 wherein said first financial institution or said second financial institution is a bank, a credit card company, a telephone company, or a processing centre.

3. A method as claimed in claim 2 wherein said first financial institution or said second financial institution is a bank.

4. A method as claimed in claim 1 wherein said first financial institution is a different financial institution than said second financial institution.

5. A method as claimed in claim 1 wherein said first financial institution and said second financial institution have a database of information related to said seller and said purchaser, respectively.

6. A method as claimed in claim 1 wherein said first financial institution and said seller are not informed of the payment preference information of said purchaser.

7. A method as claimed in claim 6 wherein said first financial institution and said seller are not informed of any information related to said purchaser so that said sale is conducted anonymously.

8. A method as claimed in claim 1 wherein said transaction key might be fixed, randomly generated, or is a fixed sequential series of alphanumeric characters.

9. A method as claimed in claim 8 wherein said transaction key is detected by said purchaser using an IR transmission or a proximity detector.

10. A method as claimed in claim 1 wherein said transaction key contains information to identify first financial institution.

11. A method as claimed in claim 1 wherein said purchaser contacts said second financial institution using a telephone, an internet-enabled device, an internet-enabled cellular telephone, a computer, or a personal digital assistant (PDA).

12. A method as claimed in claim 1 wherein said purchaser contacts said second financial institution using a device which can gain access to an Internet connection, or to an IVR application.

13. A method as claimed in claim 1 wherein access to said second financial institution is controlled by user-ids, passwords, or PIN numbers, or may be controlled by having access only to a particular device with its own user-id, password, or PIN number security.

14. A method as claimed in claim 1 wherein said sale price is converted into a selected currency prior to authorization by said purchaser.

15. A method as claimed in claim 1 wherein said sale price is a fixed amount, or is a fixed amount plus tip, or is a multiple party payment option.

16. A method as claimed in claim 1 wherein said seller is an individual or an individual acting on behalf of a business.

17. A method as claimed in claim 1 wherein said seller is an automated system.

18. A method as claimed in claim 17 wherein said automated system is a parking meter, a vending machine, a ticket machine, a gas station pump, or an ATM (automated teller machine).

19. A method as claimed in claim 1 wherein said purchaser or said seller receive alerts to inform them of account or financial activity.

20. A method as claimed in claim 19 wherein said alerts are sent by e-mail, pager or telephone.

21. A method as claimed in claim 1 where contact between said first financial institution and said second financial institution is conducted using software designed to facilitate correspondence between financial institutions.
